(19) United States
(12) Patent Application Publication
(10) Pub. No.: US 2016/0281324 A1
(43) Pub. Date: Sep. 29, 2016

(54) ARM ASSEMBLY

(71) Applicant: Caterpillar Inc., Peoria, IL (US)

(72) Inventor: EUGENE A. PASCUAL, DUNLAP, IL (US)

(73) Assignee: Caterpillar Inc., Peoria, IL (US)

(21) Appl. No.: 15/176,685

(22) Filed: Jun. 8, 2016

(51) Int. Cl. E02F 3/76; F16C 11/02; E02F 3/80

(52) U.S. Cl. CPC E02F 3/7618; E02F 3/80; F16C 11/02

(57) ABSTRACT

An arm assembly for a machine is provided, The arm assembly includes an arm having a first end and a second end. The first end is distal to the second end. The first end is adapted to be rotatably coupled to the machine. The arm assembly also includes a trunnion ball coupled to the machine. The trunnion ball defines a first axis. The arm assembly further includes a bearing rotatably coupled to the trunnion ball and the first end of the arm. The bearing defines a second axis and a third axis. The second axis of the bearing is adapted to align with the first axis defined by the trunnion ball.

### TECHNICAL FIELD

The present disclosure relates to an arm assembly. More particularly, the present disclosure relates to the arm assembly for a machine.

### BACKGROUND

Machines, such as a track type tractor, include an aim assembly to mount an implement, such as a blade, to the machine. The arm assembly includes an arm coupled to the machine via a trunnion ball and a bearing. In current configuration of the arm assembly, the arm and the bearing are mounted on the trunnion ball at an angle with respect to the trunnion ball.

In some situations, when the trunnion ball may include a truncated profile, the bearing may not be aligned with respect to the trunnion ball. As a result, the bearing may not contact the spherical surface of the trunnion ball at all times. This may result in edge loading and higher contact stress between mating surfaces of the trunnion ball and the bearing which in turn leads to uneven wear of the trunnion ball and/or the bearing. As the trunnion ball and the bearing may wear out, the contact stress may further increase between the mating surfaces of trunnion ball and the bearing resulting in accelerated wear thereof.

In some situations, during an overhaul of the machine, the bearing may be manually aligned with respect to the trunnion ball in order to improve the contact area between the bearing and the trunnion ball. Further, the bearing may be welded to the arm at the desired angle using manual adjustment. However, the desired angle may not be achieved accurately at all times due to the nature of manual adjustment.

Hence, there is a need for an improved arm assembly for such machines.

### SUMMARY OF THE DISCLOSURE

In an aspect of the present disclosure, an arm assembly for a machine is provided. The arm assembly includes an arm having a first end and a second end. The first end is distal to the second end. The first end is adapted to be rotatably coupled to the machine. The arm assembly also includes a trunnion ball coupled to the machine. The trunnion ball defines a first axis. The arm assembly further includes a bearing rotatably coupled to the trunnion ball and the first end of the arm. The bearing defines a second axis and a third axis. The second axis of the bearing is adapted to align with the first axis defined by the trunnion ball.

Other features and aspects of this disclosure will be apparent from the following description and the accompanying drawings.

### BRIEF DESCRIPTION OF THE DRAWINGS

FIG. 1 is a side view of an exemplary machine, according to one embodiment of the present disclosure;

FIG. 2 is a partial perspective exploded view of an arm assembly of the machine of FIGS. 1; and

FIG. 3 is a top view of the arm assembly of FIG. 2 in an assembled position, according to one embodiment of the present disclosure.

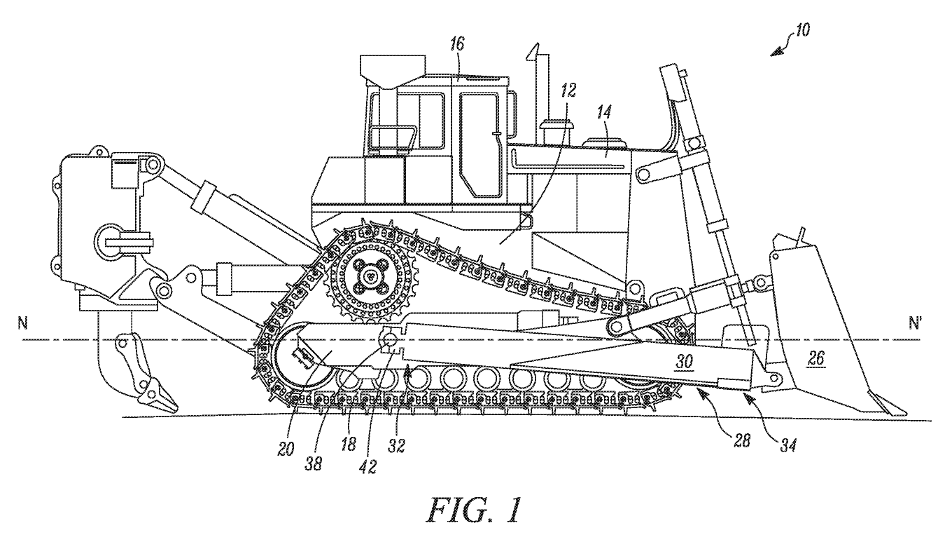

### DETAILED DESCRIPTION

Wherever possible, the same reference numbers will be used throughout the drawings to refer to the same or the like parts. Referring to FIG. 1, an exemplary machine 10 is illustrated. More specifically, the machine 10 is a track type tractor. The machine 10 is associated with an industry such as construction, mining, agriculture, material handling, and so on. The machine 10 may perform tasks including, but not limited, earth moving, demolishment, and so on.

The machine 10 includes a frame 12. The frame 12 supports one or more components of the machine 10. The machine 10 includes an enclosure 14 provided on the frame 12. The enclosure 14 encloses a power source (not shown) mounted on the frame 12. The power source may be any power source known in the art such as an internal combustion engine, batteries, motor, and so on, or a combination thereof. The power source may provide power to the machine 10 for mobility and operational requirements.

The machine 10 includes an operator cabin 16 mounted on the frame 12. The operator cabin 16 may house various controls (not shown) of the machine 10. The controls may include a steering, levers, pedals, a control console, buttons, audio visual devices, and so on. The controls may control the machine 10 on ground. The machine 10 also includes a pair of tracks 18. The track 18 is mounted to the frame 12 via one or more components such as a track roller frame 20, a drive sprocket (not shown), driven wheels (not shown), auxiliary wheels (not shown), and so on. The track 18 supports and provides mobility to the machine 10 on the ground.

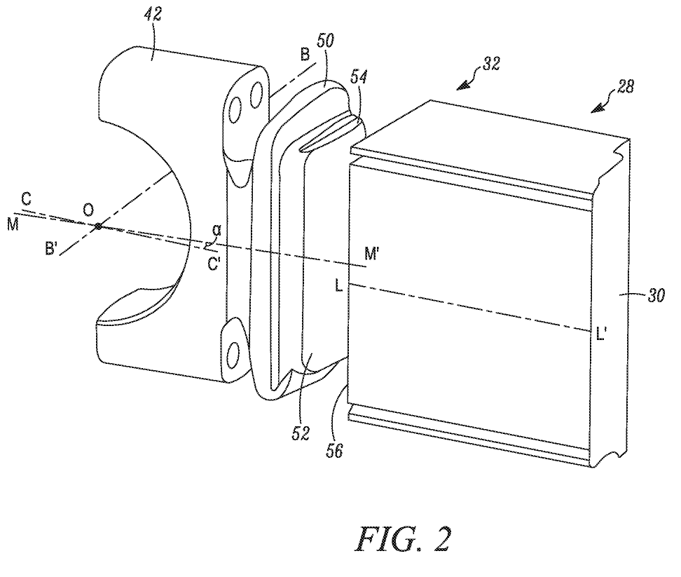

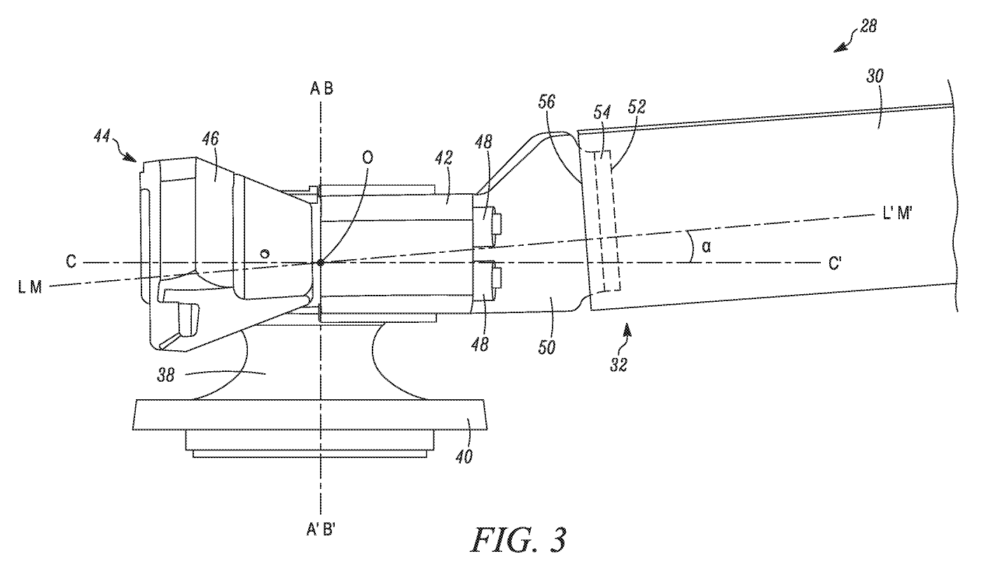

The machine 10 includes an implement such as a blade 26. The blade 26 may perform tasks such as earth moving, demolishment, and so on based on application requirements. Referring to FIGS. 1, 2 and 3, the machine 10 also includes an arm assembly 28. The arm assembly 28 mounts the blade 26 to the frame 12 of the machine 10. The arm assembly 28 includes an arm 30. The arm 30 defines a longitudinal axis L-L′ thereof. The arm 30 includes a first end 32 and a second end 34. The first end 32 is distal to the second end 34. The first end 32 is rotatably coupled to the track roller frame 20 of the machine 10 and will be explained in more detail. The second end 34 may be rotatably coupled to the blade 26 via a mounting assembly (not shown). The mounting assembly may include a pin, a bearing, and so on.

The arm assembly 28 also includes a trunnion ball 38. The trunnion ball 38 is mounted to the track roller frame 20 of the machine 10. The trunnion ball 38 is mounted to the track roller frame 20 via a flange 40. The flange 40 may be affixed to the track roller frame 20 by any fixation method such as bating, riveting, welding, and so on. The trunnion ball 38 includes a partially spherical configuration. Also, the trunnion ball 38 defines a first axis A-A′ thereof. The first axis A-A′ is a central axis of the trunnion ball 38. In the illustrated embodiment, the trunnion ball 38 is mounted to the track roller frame 20 of the machine 10 in a manner such that the first axis A-A′ is perpendicular to a longitudinal axis N-N′ of the machine 10.

The arm assembly 28 further includes a bearing 42. The bearing 42 is coupled to the first end 32 of the arm 30. The bearing 42 is also rotatably coupled to the trunnion ball 38. Accordingly, the first end 32 of the arm 30 is rotatably coupled to the trunnion ball 38. The bearing 42 may be rotatably coupled to the trunnion ball 38 via a clamping assembly 44. The clamping assembly 44 includes a cap 46. The cap 46 is coupled to the bearing 42 using bolls 48 in order to rotatably couple the bearing 42 to the trunnion ball. The bearing 42 may be any bearing known in the art such as a ball bearing, a roller bearing, and so on.

The bearing 42 defines a second axis B-B′ thereof. The second axis B-B′ is an axis of rotation of the bearing 42 and the bearing 42 rotates about a rotation point ‘O’. The bearing 42 is rotatably coupled to the trunnion ball 38 in a manner such that the second axis B-B′ is aligned with respect to the first axis A-A′ defined by the trunnion ball 38. More specifically, the second axis B-B′ defined by the bearing 42 is coaxial with respect to the first axis A-A′ defined by the trunnion ball 38. The bearing 42 also defines a third axis C-C′. The third axis C-C′ is perpendicular to the second axis B-B′ and parallel to the longitudinal axis N-N′ of the machine 10. Also, the third axis C-C′ of the bearing 42 is inclined at an angle ‘α’ with respect to the longitudinal axis of the arm 30 and will be explained in more detail. It should be noted that the angle ‘α’ may vary based on a width of the implement and the track roller frame 20 of the machine 10 based on application requirements.

More specifically, the arm assembly 28 includes an adapter 50. The adapter 50 defines a longitudinal axis M-M′ thereof. The adapter 50 is coupled between the bearing 42 and the first end 32 of the arm 30. In the illustrated embodiment, the adapter 50 and the bearing 42 are formed as a single, integral, one piece component. In other embodiments, the adapter 50 may be a separate component from the bearing 42 and may be coupled to the bearing 42 by any fixation method such as welding, bolting, other mechanical interlocking methods, and so on based on application requirements. The adapter 50 is also coupled to the first end 32 of the arm 30 by any known fixation method such as bolting, riveting, welding, and so on. In some embodiments, the adapter 50 may be integrally cast with the bearing 42 and/or the arm 30.

The adapter 50 includes a bent configuration such that the longitudinal axis M-M′ of the adapter 50 aligns at the angle ‘α’ with respect to the third axis C-C′ of the bearing 42. Also, the longitudinal axis M-M′ of the adapter 50 is aligned coaxially with respect to the longitudinal axis L-L′ of the arm 30. According, after assembly, the arm 30 and the longitudinal axis L-L′ thereof aligns at the angle ‘α’ with respect to the third axis C-C′ of the bearing 42. The adapter 50 may be made of any metal known in the art such as steel. The adapter 50 may be made by any manufacturing process known in the art such as casting, forging, and so on.

Additionally, the adapter 50 includes a protrusion 52 and a slot 54 provided thereon. During assembly, the protrusion 52 is received in the arm 30. The slot 54 mates against an end surface 56 of the arm 30. The protrusion 52 and the slot 54 establish the location and the angle orientation of the adapter 50 with respect to the arm 30. Also, the protrusion 52 and the slot 54 automatically align the adapter 50 axially with respect to the arm 30. More specifically, the protrusion 52 and the slot 54 automatically align the arm 30 at the angle ‘α’ with respect to the bearing 42. As such, the protrusion 52 and the slot 54 provide self-locating and/or self-aligning of the arm 30 and the adapter 50/bearing 42.

### INDUSTRIAL APPLICABILITY

The present disclosure relates to the arm assembly 28 for the machine 10 having the arm 30, the trunnion ball 38, the bearing 42, and the adapter 50. The bearing 42 is aligned with respect to the trunnion ball 38. In some situations, the trunnion ball 38 may not be a complete sphere. More specifically, the trunnion ball 38 may be truncated on one or more sections. In such a situation, aligning the second axis B-B′ defined by the bearing 42 with respect to the first axis A-A′ defined by the trunnion ball 38 may promote even wear of the mating surfaces thereof as the trunnion ball 38 may not be a complete sphere. Further, the adapter 50 provides aligning the arm 30 at the angle ‘α’ with respect to the bearing 42 based on application requirements. Also, the protrusion 52 and the slot 54 provide self-locating and/or self-aligning of the arm 30 and the adapter 50/bearing 42. As such, during assembly, the arm 30 and the adapter 50/bearing 42 may be connected together at the desired angle without use of any additional tool, jig, and so on thus providing a simplified assembling procedure.

The arm assembly 28 provides a simple and cost effective solution to align the bearing 42 with the trunnion ball 38 while still maintain the angle ‘α’ between the arm 30 and the longitudinal axis N-N′ of the machine 10. As a result, wear between the bearing 42 and the trunnion ball 38 is reduced in turn improving an operational life thereof, reducing service/maintenance costs, reducing machine downtime, improving machine/operational efficiency, and so on. Also, the adapter 50 is backward compatible in a manner such that the adapter 50 may be retrofitted on existing arm assemblies with minor or no modification to the existing system.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. An arm assembly for a machine, the arm assembly comprising:
an arm having a first end and a second end, the first end distal to the second end, the first end adapted to be rotatably coupled to the machine;
a trunnion ball coupled to the machine, the trunnion ball defining a. first axis;
a bearing rotatably coupled to the trunnion ball and the first end of the arm, the bearing defining a second axis and a third axis, the second axis of the bearing adapted to align with the first axis defined by the trunnion ball.

2. The arm assembly of claim 1 including an adapter coupled to the bearing and the first end of the arm, the adapter adapted to align the third axis of the bearing at an angle with respect to a longitudinal axis of the arm.

3. The arm assembly of claim 2 including a protrusion and a slot provided on the adapter, the protrusion and the slot adapted to align the adapter with respect to the arm.

4. The arm assembly of claim 1, wherein the second end of the arm is rotatably coupled to an implement of the machine.
